(19) United States
(12) Patent Application Publication
(10) Pub. No.: US 2026/0276156 A1
(43) Pub. Date: Sep. 17, 2026

(54) PRESSURE VESSEL SYSTEM AND/OR METHOD THEREFORE

(71) Applicant: Verne Inc., San Francisco, CA (US)

(72) Inventors: David E. Jaramillo, San Francisco, CA (US); Enrique Nuñez Garcia, San Francisco, CA (US); Kaushik Mallick, San Francisco, CA (US); Burak Oner, San Francisco, CA (US); Vincent Heloin, San Francisco, CA (US)

(73) Assignee: Verne Inc., San Francisco, CA (US)

(21) Appl. No.: 19/215,829

(22) Filed: May 22, 2025

Related U.S. Application Data
(60) Provisional application No. 63/650,468, filed on May 22, 2024.

(51) Int. Cl. F17C 13/08; F17C 1/06

(52) U.S. Cl. CPC F17C 13/086; F17C 1/06; F17C 2201/0109; F17C 2203/0391; F17C 2203/0629; F17C 2205/0103; F17C 2205/0192; F17C 2223/0161; F17C 2260/031

(57) ABSTRACT

The pressure vessel system can include: an inner tank, a jacket, a set of supports, and a set of tubes (a.k.a., fill tubes). The system can optionally include a set of mounts. The system can function to fluidly isolate a first chamber (e.g., interstitial vacuum chamber) between the jacket and the inner tank and a second chamber within the inner tank (e.g., storage chamber for cryo-compressed hydrogen). Additionally, the system can function to structurally support the inner tank while allowing relative motion between the inner tank and the jacket along an interface of a support, which can mechanically constrain the inner tank while allowing expansion of the inner tank within the first chamber (and/or deformation relative to the jacket).

### CROSS-REFERENCE TO RELATED APPLICATIONS

This application claims the benefit of U.S Provisional Application number 63/650,468 filed 22 May 2024, which is incorporated in its entirety by this reference.

### TECHNICAL FIELD

This invention relates generally to the fluid storage field, and more specifically to a new and useful pressure vessel system in the fluid storage field.

### BRIEF DESCRIPTION OF THE SEVERAL VIEWS OF THE DRAWINGS

FIG. 1 is a schematic representation of a variant of the pressure vessel system.

FIG. 2 is a schematic representation of a variant of the pressure vessel system.

FIG. 3 is a partial schematic representation of a variant of the pressure vessel system which illustrates an example conductive heat flow path between the inner tank and the jacket.

FIGS. 4A-4B are an isometric view and a cross-sectional cutaway view, respectively, of a support in one or more variants of the pressure vessel system.

FIG. 5 is an exploded assembly view of a support in one or more variants of the pressure vessel system.

FIGS. 6A-6B are diagrams of a first and a second support, respectively, in a variant of the pressure vessel system, indicating mechanical constraints.

FIG. 7 is an isometric view of a variant of the pressure vessel system.

FIG. 8 is an example cross sectional view of a support in one or more variants of the pressure vessel system.

FIG. 9 is a partial cross-sectional view of a variant of the pressure vessel system.

FIGS. 10A-10B are a side view and an isometric view, respectively, of a support in one or more variants of the pressure vessel system.

FIG. 11 is a tabular example of support constraints in one or more variants of the pressure vessel system.

FIGS. 12A and 12B are schematic representations of variants of fill tube arrangements.

FIGS. 13A and 13B are schematic representations of a variant of fill tube arrangement.

FIG. 14 is a schematic representation of a variant of fill tube arrangement.

FIG. 15 is a schematic representation of a variant of the system.

### DETAILED DESCRIPTION OF THE INVENTION

The following description of the embodiments of the invention is not intended to limit the invention to these embodiments, but rather to enable any person skilled in the art to make and use this invention.

### 1. Overview

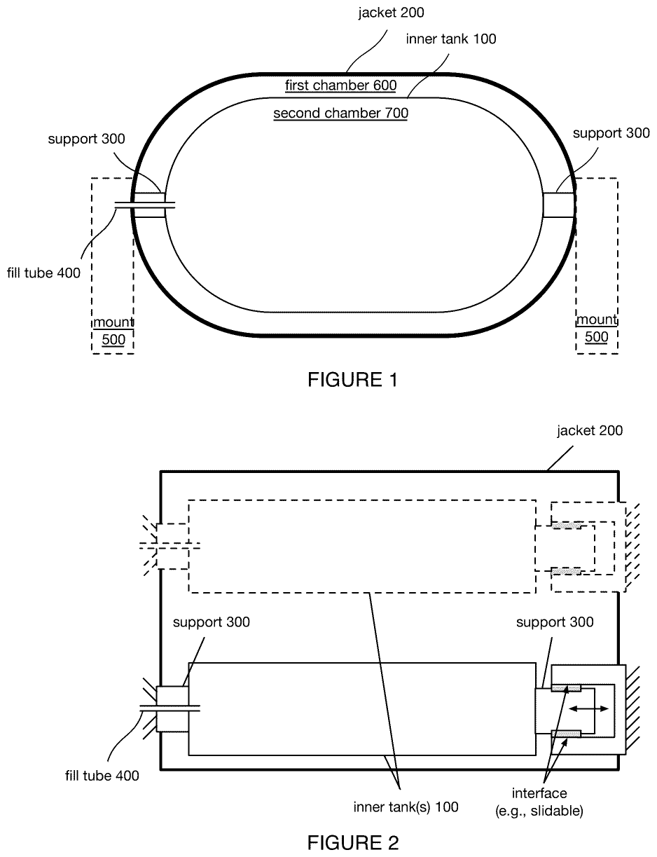

The pressure vessel system, an example of which is shown in FIG. 1, can include: an inner tank 100, a jacket 200, a set of supports 300, and a set of tubes (a.k.a., fill tubes) 400. The system can optionally include a set of mounts 500. However, the system 100 can additionally or alternatively include any other suitable set of components. The system can function to fluidly isolate a first chamber 600 (e.g., interstitial vacuum chamber) between the jacket and the inner tank and a second chamber 700 within the inner tank (e.g., storage chamber for cryo-compressed hydrogen). Additionally, the system can function to structurally support the inner tank while allowing relative motion between the inner tank and the jacket along an interface of a support, which can mechanically constrain the inner tank while allowing expansion of the inner tank within the first chamber (and/or deformation relative to the jacket). Additionally, the system can function to facilitate fluid exchange between the inner tank and external system(s) via the fill tube(s). Additionally, the system can function to (partially) thermally insulate a fluid medium (e.g., CCH2) within the second chamber of the inner tank and/or reduce heat flow between the external environment and the fluid medium. However, the system can provide any other suitable functionalities.

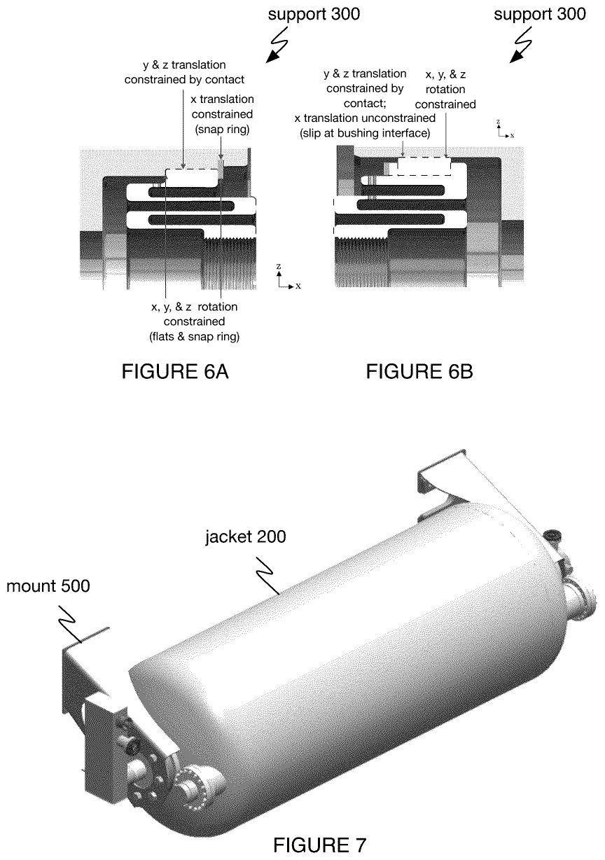

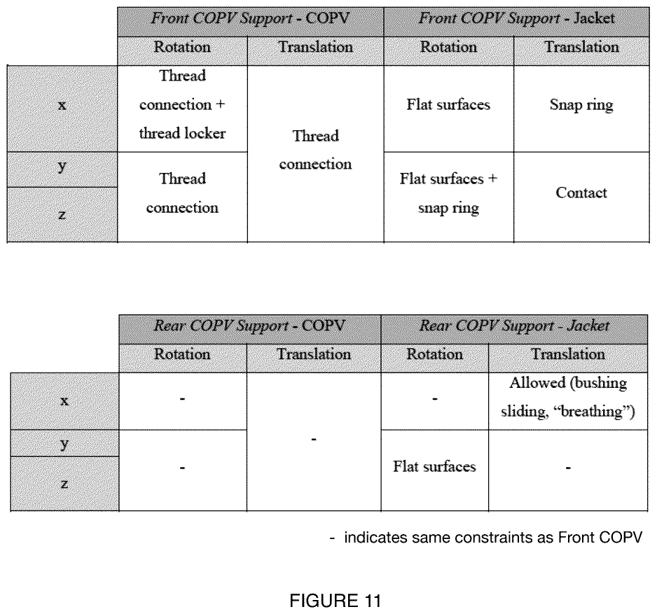

In an illustrative example, the pressure vessel system includes a double-walled Composite Overwrapped Pressure Vessel (COPV). For instance, the vessel can include a fixed outer wall and a COPV, within the fixed outer wall, which forms an inner wall of the double walled pressure vessel system, with an interstitial vacuum space between the fixed outer wall and the inner wall (i.e., COPV). The COPV can be configured to expand within the fixed outer wall as a function of internal pressure and temperature, while constrained relative to the outer wall. For instance, the COPV can be constrained in 6 degrees of freedom at a first neck mount and 5 degrees of freedom at a second neck mount opposite the first neck mount along a central axis of the COPV (e.g., a table of example constraints is shown in FIG. 11; example constraints are shown in FIG. 6A and FIG. 6B; where the axial position of the second neck mount is defined and/or constrained by the variable axial length of the COPV, which may fully constrain and/or avoid over constraining the COPV under varying temperature and pressure), which may allow relative motion at the second neck mount (e.g., axial translation to accommodate COPV expansion and contraction).

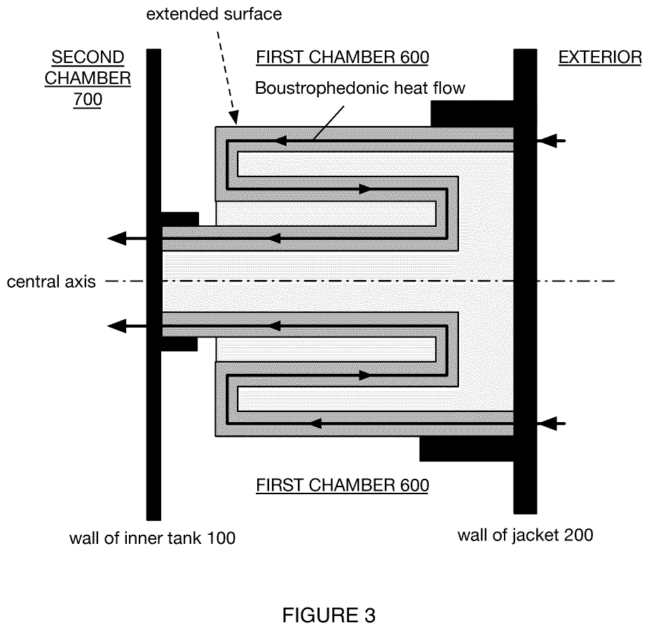

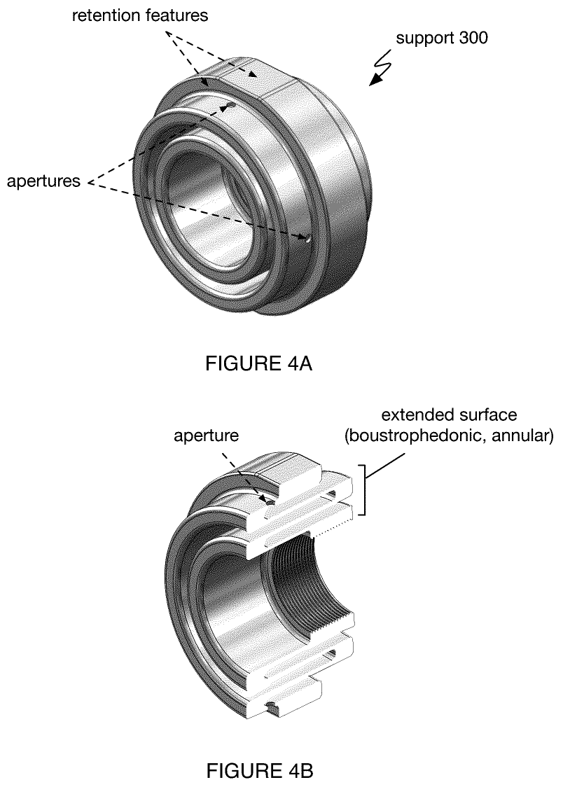

The term “extended surfaces” as used herein, in reference to the set of supports or otherwise, preferably refers to body structures, geometries, and/or surfaces which increase the net surface area (and convection rate) between a body and an adjacent fluid, relative to a reference surface (with no fins, protrusions, curves, etc.). At low fluid pressures (e.g., vacuum pressure, less than 1 bar, less than 0.1 bar, less than 0.01 bar, etc.) such as may exist in the interstitial chamber between the jacket and the inner tank, convective heat transfer may be negligible and/or may have minimal impact on net thermal resistance, since conduction may be the primary mode of heat transfer (e.g., more than 50%, 60%, 75%, 80%, 85%, 90%, 95%, 98%, 99%, 99.9%, etc. of heat flow may occur by conduction). Extended surfaces and/or extended surface structures may instead be utilized to increase thermal resistance by extending/lengthening the minimum contiguous path length through a solid body(ies), between ends of the solid body(ies) and/or relative to any other suitable body portions (e.g., example shown in FIG. 4B). Accordingly, extended surfaces may additionally be used herein to refer to geometries and structures which increase thermal conductance and/or path length of conductive heat flow through a body (e.g., contacting to two bodies with a net temperature difference; between solid bodies) to net insulative effect. For example, (insulating) extended surfaces may be arcuate (e.g., which may increase length relative to a line segment between endpoints or a distance between parallel lines on a plane), serpentine (e.g., a sequence of arcuate segments or straight segment equivalents forming a triangle wave or zig zag), boustrophedonic, wavy, spiraling, coiled, helical, pocketed, bent, and/or may have any other suitable structures/geometries. An example of an (insulating) extended surface is shown in FIG. 3. A second example of an (insulating) extended surface is shown in FIGS. 4A-4B. However, the term extended surface and/or insulating extended surface may be otherwise suitably used/referenced herein, and/or may have any other suitable meaning(s).

The term “substantially” as utilized herein can mean: exactly, approximately, within a predetermined threshold or tolerance, and/or have any other suitable meaning.

### 2. Technical Advantages

Variants of the technology can confer one or more advantages over conventional technologies.

First, variations of this technology can structurally support an expandable inner tank (e.g., COPV) under varying temperatures (e.g., temperature range may be upwards of 300K in various configurations), pressures (e.g., pressure range may be upwards of 100 bar, 300 bar, 500 bar, 700 bar, etc.), stored fluid mass (e.g., 0 kg, 100 kg, 200 kg, 400 kg, 800 kg, etc.), vibration (e.g., especially in a frequency range of roadway induced vehicular vibration, such as about 1 Hz to 10 Hz), acceleration (e.g., 2 g in all axes), weight vectors (e.g., in various mounting configurations/orientations), and/or in any other suitable environments and/or operating conditions. For example, variations can mechanically support the inner tank within an interstitial (vacuum) chamber of a jacket under stresses resulting from reaction forces (e.g., weight, accelerations, etc.). As a second example, variations can facilitate vehicular integration of cryo-compression vessels, such as to facilitate cryo-compressed fuel (e.g., LH2, GH2, and/or a mixture thereof) to be used for vehicular propulsion (e.g., in a hydrogen-electric vehicle). Additionally, variants can reduce thermal conductance between a stored fluid (e.g., LH2; cryo-compressed fluid) and an exterior, reduce outgassing to a fluid chamber(s) and the ambient environment, and/or provide fire retardation for the stored fluid.

Second, variations of this technology can facilitate the structural support of a variable geometry vessel (e.g., COPV) within a multi-layer insulation (MLI) vessel (e.g., double walled vessel) and/or can accommodate expansionary mismatch between chambers of a multi-chamber pressure vessel (e.g., expansion of an inner tank within an interstitial vacuum chamber of a MLI vessel; expansion mismatch between walls of a double walled pressure vessel). For instance, variants can facilitate relative motion between portions of the inner tank and a surrounding jacket at a slidable interface, such as a bearing surface of a self-lubricating bushing, to accommodate changes in the inner tank geometry relative to the jacket (i.e., the inner tank can expand/contract within the interstitial chamber while structurally supported relative to the jacket).

Third, variations of this technology can utilize extended surfaces and/or lengthened thermal conduction paths to reduce conductive heat transfer across a vacuum barrier (i.e., first chamber) of an MLI pressure vessel (e.g., between the inner tank and outer jacket). For example, a set of (annular) supports, mechanically coupling the inner tank to the jacket, can define a boustrophedonic conduction path(s) between walls (i.e., between the inner tank and the jacket) to reduce the thermal conductance. As a second example, the set of supports can boustrophedonically couple a plurality of concentric annuli (e.g., within the first chamber; offset within vacuum space; forming a contiguous, unitary body; etc.) to mechanically couple the inner tank to the jacket. Such variants can advantageously increase the thermal resistance between a cryo-storage chamber (e.g., second chamber) and/or fluid medium (e.g., LH2) and the exterior environment.

Fourth, variants of this technology can facilitate integration of cryo-compressed hydrogen (CCH2) storage onboard a vehicle within the mechanical constraints of a (roadway) vehicle environment (e.g., acceleration; shock/vibration; Gross Vehicle Weight [GVW] regulatory constraints; fireproofing; etc.). For example, variants can facilitate CCH2 storage onboard roadway vehicles, heavy-duty vehicles, aircraft, spacecraft, watercraft, rail vehicles, and/or any other suitable vehicle(s). In variants, the usage of longitudinally-opposite neck-mounted supports can minimize vibrational moments on supports of the inner tank and/or on mounts due to vehicle vibration. The reduction of vibrational moments can improve system lifetime, reliability, and/or performance.

However, further advantages can be provided by the system and method disclosed herein.

### 3. System

The pressure vessel system, an example of which is shown in FIG. 1, can include: an inner tank 100, a jacket 200, a set of supports 300, and a set of tubes (a.k.a., fill tubes) 400. The system can optionally include a set of mounts 500. However, the system 100 can additionally or alternatively include any other suitable set of components.

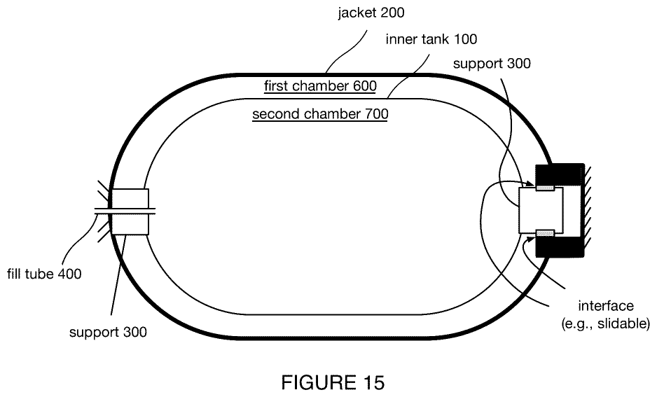

The system can function to fluidly isolate a first chamber 600 (e.g., interstitial vacuum chamber) between the jacket and the inner tank and a second chamber 700 within the inner tank (e.g., storage chamber for cryo-compressed hydrogen). Additionally, the system can function to structurally support the inner tank while allowing relative motion between the inner tank and the jacket along an interface of a support, which can mechanically constrain the inner tank while allowing expansion of the inner tank within the first chamber (and/or deformation relative to the jacket; e.g., example shown in FIG. 15). Additionally, the system can function to facilitate fluid exchange between the inner tank and external system(s) via the fill tube(s). Additionally, the system can function to (partially) thermally insulate a fluid medium (e.g., CCH2) within the second chamber of the inner tank and/or reduce heat flow between the external environment and the fluid medium. However, the system can provide any other suitable functionalities.

The inner tank functions to enclose and/or house a fluid medium, such as CCH2, within an interior of the inner tank (i.e., second chamber). Additionally or alternatively, the inner tank can function to substantially fluidly isolate an interior of a second chamber and/or a fluid medium stored therein from the first chamber (i.e., interstitial space between the inner tank and the jacket).

The inner tank preferably includes a Composite Overwrapped Pressure Vessel (COPV), but can additionally or alternatively include: an expandable pressure vessel, thin-walled pressure vessel (e.g., flexible-walled pressure vessel, semi-rigid, variable geometry, etc.), full-metal pressure vessel, hoop-wrapped pressure vessel, fully-wrapped pressure vessel (e.g., metal-lined, non-metal lined), and/or any other suitable pressure vessel. Additionally, the inner tank can optionally include one or more insulating layers/coatings, such as: paint, epoxy, thermal barrier coatings (TBCs), metals, polymers, composites (e.g., fiberglass, carbon fiber, synthetic fiber, aramid fiber, Kevlar®, etc.), thermoplastics, thermoset materials, and/or any other suitable material(s)/layer(s). For example, the inner tank can be a COPV with a metal liner (e.g., aluminum; rolled cylinder with welded hemispherical caps) with a composite overwrap (e.g., carbon fiber suspended in an epoxy matrix; etc.). The inner tank can be a type I pressure vessel (all metal), a type II pressure vessel (metal liner, hoop wrapping along cylindrical portion), a type III pressure vessel (metal liner, full composite overwrap over both the cylindrical portion and the domed ends) a type IV pressure vessel (e.g., a polymer liner), a type 5 pressure vessel (e.g., a linerless composite vessel), and/or any other suitable type of pressure vessel.

The inner tank can be spherical, semi-spherical, partially spherical, ellipsoidal, isotensoidal, cylindrical, domed/capped, and/or can have any other suitable geometry. The shape of the inner tank can be oriented along a central axis (e.g., a longitudinal axis, etc.). More preferably, the inner tank is cylindrical with domed (e.g., hemispherical, elliptical, isotensoidal, etc.) ends. However, the inner tank can have any other suitable geometry/structure.

The inner tank is preferably configured to be neck-mounted (e.g., supported at opposing ends, such as opposite domed ends of a pressure vessel cylinder along the central axis of the cylinder) but can additionally or alternatively be base-mounted, side-mounted (e.g., supported along the outer wall/diameter), and/or configured to be otherwise suitably mounted/supported by the set of supports in any other arrangement(s). In an example, all conductive thermal paths between the inner tank and the jacket pass through the first neck (e.g., at a first end of the inner tank) or the second neck (e.g., at a second end of the inner tank).

During a filling cycle (e.g., filling and pressurizing the inner tank, etc.), the inner tank can expand or contract along the central axis by 0.01%, 0.1%, 0.5%, 1%, 2%, 3%, 5%, 8%, can expand or contract along the central axis within an open or closed range bounded by the aforementioned values, and/or any other suitable range. In an example, the inner tank expands along the central axis (e.g., along the central axis, etc.) by a value less than a length (e.g., 50%, 80%, 90%, 95%, 99%, etc.) of a slidable interface between the support (and/or bushing thereof) and the jacket (e.g., to prevent fluid flow into the interstitial space, etc.). In a variant, the inner tank can expand while the jacket remains a fixed size, thus reducing the volume of the first chamber. In an example, the first chamber (e.g., interstitial fluid chamber) has a variable volume and the jacket has a substantially fixed volume).

The inner tank can be pressurized (e.g., from an atmospheric pressure of 1 bar, etc.) to a pressure of 50 bar, 100 bar, 200 bar, 300 bar, 500 bar, 700 bar, 800 bar, a pressure within an open or closed range bounded by any of the aforementioned values, and/or any other suitable range. In variants, the aforementioned values can represent a maximum pressure value of the inner tank in a filling cycle.

During a filling cycle, the system and/or components thereof (e.g., the inner tank, fill tubes, etc.) can change in temperature from an ambient temperature to a chilled temperature. The inner tank can be cooled (e.g., from an ambient temperature, such as 250°K, 270°K, 280°K, 310°K, a temperature within an open or closed range bounded by the aforementioned values, etc.) to a cooled temperature of 10°K, 25°K, 40°K, 50°K, 58°K, 70°K, 80°K, 100°K, a temperature within an open or closed range bounded by the aforementioned values, and/or any other suitable temperature. In variants, the cooled temperature values can represent a minimum temperature value of the inner tank in a filling cycle.

The inner tank preferably stores cryo-compressed hydrogen, but can additionally or alternatively store any suitable fluid in any other suitable state. Examples of fluid types can include GH2 (e.g., green hydrogen, etc.), hydrogen, nitrogen, oxygen, helium, natural gas (LNG), argon, air, and/or any other suitable fluid. Examples of fluid states can include liquid, gas, cryo-compressed liquid, subcooled liquid, dense phase liquid, and/or any other suitable fluid state.

The filling portion of the filling cycle (e.g., filling the tank with the stored fluid, etc.) can last 1 minute, 5 minutes, 10 minutes, 15 minutes, 20 minutes, a temporal length in an open or closed range bounded by the aforementioned values, and/or any other suitable range. An emptying portion of the filling cycle (e.g., draining the stored fluid from the tank) can be 1 minute, 5 minutes, 10 minutes, 15 minutes, 20 minutes, 40 minutes, 1 hour, a temporal length in an open or closed range bounded by the aforementioned values, and/or any other suitable range.

In a first variant, during the filling portion, the inner tank is filled through a single fill tube. In a second variant, the inner tank is filled through multiple fill tubes, wherein a pump forces fluid into the inner tank. In a third variant, the inner tube is filled through multiple fill tubes, wherein a pump forces fluid into the inner tank via a first subset of fill tubes and out of the inner tank via a second subset of fill tubes.

In variants, the inner tank can include the tank, insert(s), and/or any other suitable element(s) as described in U.S. application Ser. No. 18/689,028, filed 4-Mar.-2024, titled “COMPACT INSERTS FOR CRYO-COMPRESSED STORAGE VESSELS”, International Application Serial No. PCT/US 2023/027986, filed 18-Jul.-2023, titled “SYSTEM AND METHOD FOR MULTI-TANK CRYO-COMPRESSED HYDROGEN STORAGE AND OPERATION”, and/or U.S. application Ser. No. 18/916,032, filed 15-Oct.-2024, titled “COMPOSITE-OVERWRAPPED PRESSURE VESSEL SYSTEM” each of which is incorporated herein in its entirety by this reference.

However, the system can include any other suitable inner tank.

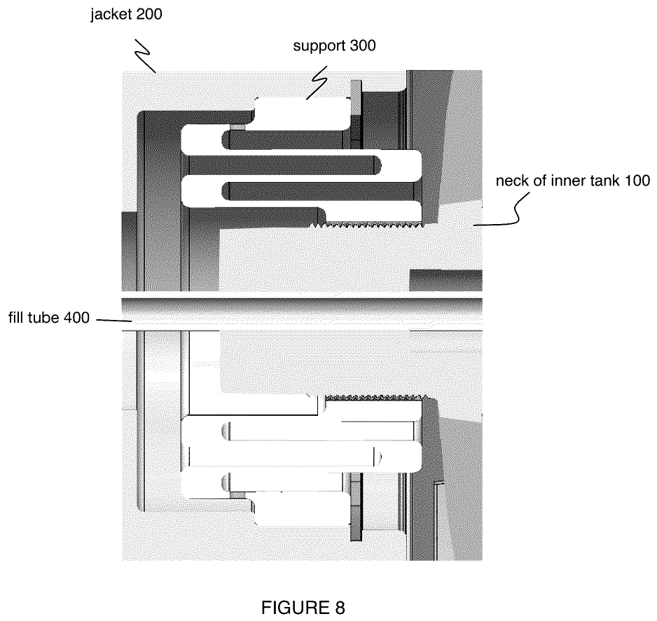

The jacket functions to enclose the inner tank and/or (partially) thermally insulate the inner tank from an exterior environment. Additionally, the jacket can function to (substantially) fluidly isolate a first chamber from an exterior environment. For example, the jacket interior can enclose and fluidly isolate interstitial space (e.g., the first chamber) between the jacket and the inner tank. More preferably, the jacket can be substantially rigid (e.g., a rigid enclosure), static, nondeformable, and/or size invariant under nominal operating conditions (e.g., geometry is independent of fluid medium temperature and/or pressure; non-expandable fluid vessel) and configured to maintain negative pressure within the first chamber (e.g., relative to ambient and/or exterior pressure; partial vacuum). For example, the jacket can be configured to fluidly isolate an interstitial space (a.k.a., first chamber) between the jacket and the inner tank, with a pressure less than: 1 bar, 0.1 bar, 0.05 bar, 0.02 bar, 0.01 bar, 0.005 bar, 0.001 bar, 0.0001 bar, 0.0005 bar, 0.00001 bar, any open or closed range bounded by the aforementioned values, and/or any other suitable pressure(s). Alternatively, the first chamber can be pressurized (e.g., with inert gas), unpressurized (e.g., at atmospheric pressure; selectively fluidly coupled to atmospheric pressure, etc.), and/or can have any other suitable pressure (and/or vacuum pressure). The jacket can include any suitable materials and/or layers, such as: metals (e.g., stainless steel, titanium, aluminum, etc. ; alloyed, non-alloyed; etc.), composites (e.g., fiberglass, carbon fiber, etc.), polymers (e.g., PMI), thermoset layers/coatings, thermoplastics, aerogel, foam, MLI layers, and/or any other suitable material(s) and/or layer(s). The jacket and/or layers thereof can be formed as a unitary, contiguous body (e.g., unibody composite, weldment enclosure, etc.) and/or can include an assembly of multiple (e.g., exterior) layers, reinforcing structures, and/or insulation (e.g., external foam insulation, peripheral mounts, etc.). As an example, the outer jacket can include a stainless-steel enclosure (e.g., cylinder with domed ends, an example is shown in FIG. 7). As a second example, the outer jacket can include an aluminum weldment. The jacket can enclose and/or mechanically couple to exactly one inner tank (e.g., such as forming a double walled cylinder) and/or multiple inner tanks (e.g., an example is shown in FIG. 2). In variants with multiple inner tanks, the inner tanks can share the same fill tube(s) or can use different fill tubes. The jacket geometry can be substantially similar to the inner tank (e.g., nested, concentric cylinders, etc.) or different (e.g., an example is shown in FIG. 2). The jacket can be cylindrical (e.g., an example is shown in FIG. 7), prismatic, domed/capped (e.g., hemispherical ends, bowed at the ends), ellipsoidal (e.g., prolate, oblate, etc.), spherical, semi-spherical, and/or can have any other suitable geometry/features. The jacket can be configured to be neck-mounted (e.g., supported at opposing ends, such as opposite domed ends of a pressure vessel cylinder along the central axis of the cylinder) and/or secured at a set of mounts aligned with each of the set of supports, but can additionally or alternatively be base-mounted, side-mounted (e.g., supported along the outer wall/diameter), and/or configured to be otherwise suitably mounted/supported in any other arrangement(s). The jacket can have the same mounting support arrangement as the inner tank(s) and supports (e.g., neck mounted along opposing ends) and/or a different mounting arrangement. Additionally, the jacket is preferably mechanically coupled to the inner tank by the set of supports and configured to structurally support the inner tank and the set of supports.

The jacket can optionally include a set of fill apertures (e.g., apertures through which a set of fill tubes can pass through the jacket. In a preferred variant, the set of fill apertures are at one or both longitudinal ends of the jacket (e.g., ends on opposite ends of a central axis of the jacket). However, the set of fill apertures can additionally or alternatively include fill apertures at a side section of the jacket (e.g., at a midsection of the jacket, pointing radially inward relative to the central axis of the inner tank, etc.).

In variants, the jacket and/or inner tank materials can be selected to reduce outgassing within the first chamber. For example, the jacket can include a rolled stainless-steel cylinder with welded, domed end caps (e.g., partially spherical, hemispherical, etc.).

In variants, the jacket can include or be used with the outer jacket, insulation layers, MLI structures, and/or any other suitable set of elements as described in U.S. application Ser. No. 18/689,028, filed 04-Mar-2024, titled “COMPACT INSERTS FOR CRYO-COMPRESSED STORAGE VESSELS”, and/or International Application Serial No. PCT/US2023/027986,filed 18-Jul-2023, titled “SYSTEM AND METHOD FOR MULTI-TANK CRYO-COMPRESSED HYDROGEN STORAGE AND OPERATION”, each of which is incorporated herein in its entirety by this reference.

However, the system can include any other suitable jacket(s) and/or MLI enclosure(s).

The fill tube(s) 500 can function to fluidly couple the second chamber 700 (i.e., inner tank interior) to an external fluid system(s). For example, the set of (fill) tubes can connect the pressure vessel system to the system(s) and/or elements as described in U.S. application Ser. No. 18/259,902, filed 29-Jun-2023, titled “CRYO-COMPRESSED HYDROGEN STORAGE MULTI-TANK SYSTEMS AND THEIR THERMAL MANAGEMENT”, which is incorporated herein in its entirety by this reference. Additionally or alternatively, the fill tubes can function to supply a fluid medium to (or from) the second chamber. The pressure vessel system can include a single fill tube (e.g., at a neck of the inner tank) but can additionally or alternatively include multiple fill tubes (e.g., at a first neck of the inner tank and a second neck of the inner tank, to facilitate through-flow of material during filling; one fill tube for each of a plurality of inner tanks; multiple tubes at a single end/neck of the inner tank, etc.), and/or any other suitable number of fill tubes. In variants with multiple fill tubes for an inner tank, the fill tubes can be attached to the inner tank at the supports (e.g., at a central axis of the inner tank, etc.), proximal the supports (e.g., directly to the inner tank at a point offset from the central axis, etc.), at a wide midsection of the inner tank, and/or at any other suitable position. In a first variant, the system can include a single fill tube connection to the inner tank at a first support at one neck of the inner tank. In a second variant, the system can include a pair of fill tubes, each at a support of longitudinally opposite necks of the inner tank. In a third variant, the system can include a pair of fill tubes at the same support of the inner tube. However, the fill tubes can be otherwise numbered and/or oriented. The fill tube is preferably fixed to the inner tank (e.g., at a neck and/or support mounting location), but can additionally or alternatively be mechanically coupled to the outer chamber, a support(s), a mount(s), and/or any other suitable components. For example, the fill tube can be structurally supported by the jacket and the inner tank and extend through the first chamber (i.e., surrounded by vacuum in interstitial space). Additionally or alternatively, the fill tube and the inner tank can cooperatively define a fluid envelope, which can be sealed and/or regulated by a valve (e.g., at an interior of the jacket, externally, etc.).

In variants, the fill tube can connect a region outside of the jacket to the inner tank via the support.

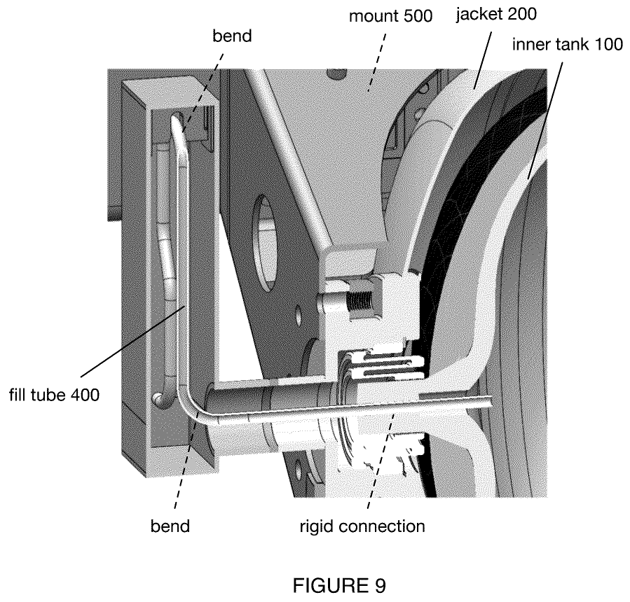

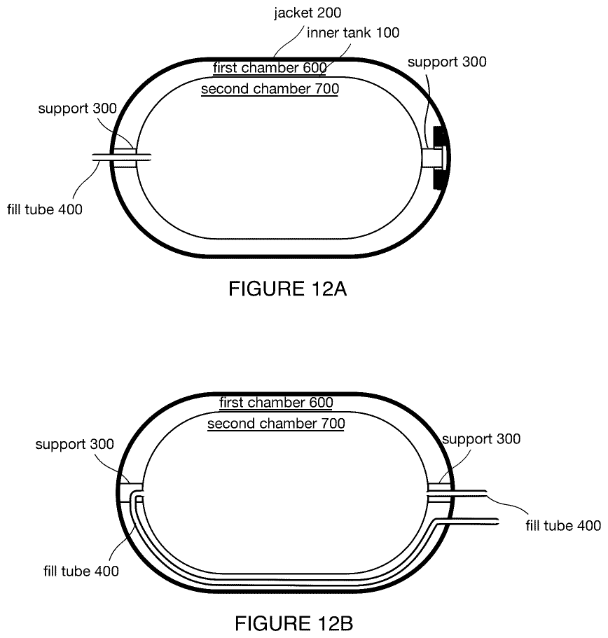

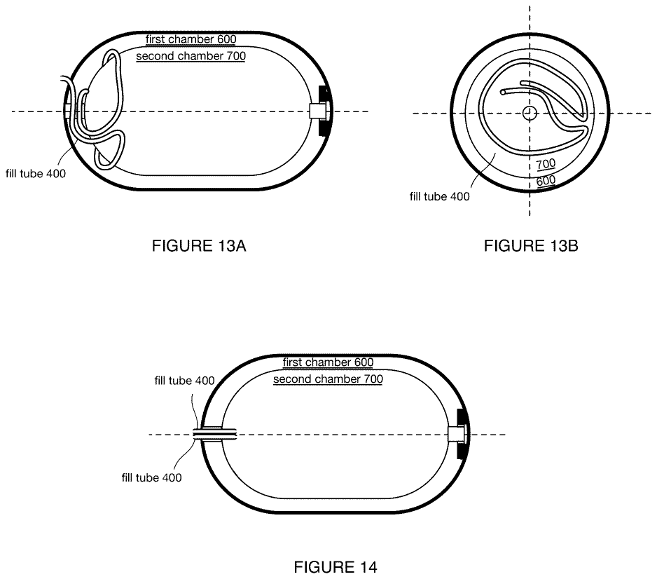

In a first variant, the fill tube can linearly connect the region outside of the jacket to the inner tank (e.g., example shown in FIG. 9 and FIG. 12A). In this variant, the fill tube preferably extends along a central axis of the system, but can alternatively be offset from the central axis. In a second variant, the fill tube can take a circuitous path within the interstitial region (e.g., to increase a length of a thermal pathway along the tube itself. In a first example of this variant, the tube circumscribes the central axis proximal to a dome of the inner tank (e.g., example shown in FIG. 13A and FIG. 13B). In this example, the fill tube can circumscribe 360°, 330°, 270°, 180°, 90°, and/or any other suitable angular segment of a circumference around the central axis. In a second example of this variant, the fill tube can take a serpentine path (e.g., following a boustrophedonic pattern, etc.) within the interstitial region. In a third example of this variant, the fill tube can traverse a length of the interstitial region (e.g., without touching the inner tank or jacket within the traversal region, etc.) and exit the jacket at an opposite end of the system as an inner tank-fill tube inlet point (e.g., example shown in FIG. 12B). In a fourth example, the fill tube can follow a helical path (e.g., with a helical centerline along the central axis or separate from the central axis. In a third variant, the system can include multiple fill tubes proximal to the central axis (e.g., example shown in FIG. 14). In an example of this variant, a first fill tube of a pair of fill tubes can be a tank inlet and a second fill tube of the pair of tubes can be a tank outlet. In an alternative variant, the fill tube connects a substantially spherical or cylindrical surface of the inner tank at a point offset from the central axis of the inner tank to a substantially spherical or cylindrical surface of the jacket. The aforementioned examples and variants are non-exclusive. However, the fill tube can follow any other suitable path and/or arrangement.

The fill tube is preferably metal (e.g., stainless steel), but can have any other suitable material construction. The fill tube can include straight segments, arcuate segments/sections (e.g., bends), uniform cross sections (e.g., annular), non-uniform cross sections, and/or any other suitable geometry/construction. More preferably, the fill tube(s) can include a plurality of bends (e.g., in at least two orthogonal planes; an example is shown in FIG. 9) or curves between the fixed ends, which functions to relieve stress concentrations which may arise from expansion/contraction, such as may arise from coefficient of thermal expansion (CTE) mismatch between components and/or strain deformation(s) resulting from structural loads, vibration, inertia, and/or pressure differential(s) throughout the system. For example, a bend(s) may absorb minor expansions and contractions of the fill tube relative to the jacket and/or mounts, such as by marginal bend angle deflections, which may reduce fatigue and/or stress concentrations within the fill tube (e.g., which may improve cyclic performance characteristics and lifetime), which may be particularly advantageous when the fill tube is in contact with low temperature fluids (e.g., CCH2) and a large temperature difference (e.g., over 200K) may exist between the fill tube and the surroundings (e.g., jacket, exterior, etc.). However, the tube(s) can additionally or alternatively include a single bend (e.g., within a single plane), 3D bends, one or more bends lying in a unitary reference plane, and/or any other suitable bends/structures defining any other suitable 2D/3D path(s).

In variants, the fill tube(s) can extend through a thickness of the jacket, supports, and/or inner tank (e.g., an example is shown in FIG. 8; a second example is shown in FIG. 9), but can be otherwise configured. As an example, a fill tube can extend (axially) along a central axis of the pressure vessel through a neck of the inner tank and a (neck-mounting) support.

However, the system can include or be used in conjunction with any other suitable set of fill tubes. Additionally or alternatively, the fill tubes can alternatively be internally or externally sealed in one or more configuration(s) of the system, and/or may be altogether excluded on one or more ends of the pressure vessel and/or walls of the pressure vessel.

The set of supports 300 functions to mechanically couple the inner tank to the jacket. Additionally or alternatively, the set of supports can mount and/or structurally support a fill tube and/or provide any other suitable functionalities.

In a variant, the set of supports can be shaped to maximize a distance of a thermal path between the inner tank and the jacket (e.g., to increase thermal resistance) while maintaining a rigid connection between the inner tank and the jacket (e.g., to maintain support of the inner tank)

The set of supports are preferably arranged within the first chamber (i.e., interstitial vacuum space between the jacket and inner tank)., but can additionally or alternatively form part of the first chamber and/or partially enclose a fluid envelope of the first chamber. For example, a support can be sealed against an interior surface of the jacket and/or close out a portion of the jacket (i.e., cooperatively forming an enclosure). In an alternative example, a support can be entirely arranged within the first chamber and fluidly isolated within the first chamber. However, supports can be otherwise suitable arranged. In a variant, a support divides a second portion of the first chamber from the first portion of the first chamber.

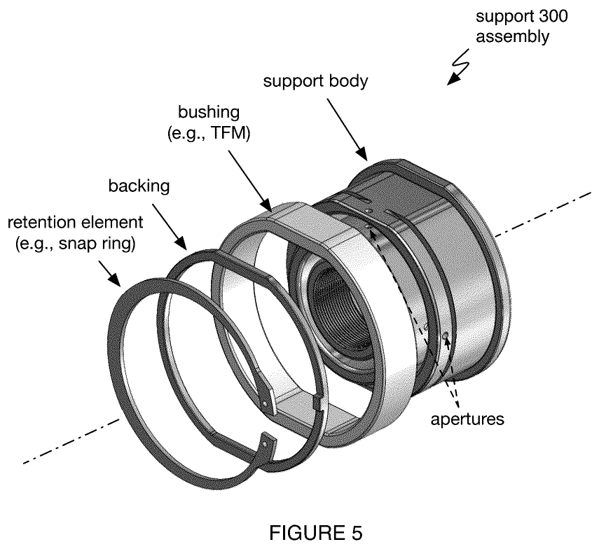

The pressure vessel system preferably includes a pair of supports (e.g., at opposing ends of the inner tank along a central axis, etc.), but can additionally or alternatively include a unitary support (e.g., central body structure; for a vertically mounted tank, etc.), a plurality of supports (e.g., exactly two, three, four, five, six, more than six, etc.), and/or any other suitable number of supports. The supports are preferably asymmetric with respect to constraints (e.g., fixed at one end and partially unconstrained at an opposite end from the one end; with a set of asymmetric fill tube pass-throughs), but can alternatively be symmetric (e.g., about a midplane orthogonal to a central axis of the inner tank), and/or can be otherwise configured. Supports can include: unitary support bodies (e.g., single formed from a single body, such as a body machined or cast without welds; directly coupled to both the jacket and the inner tank; an example is shown in FIGS. 4A-4B) and/or assemblies (e.g., formed from multiple components/materials, etc. ; an example is shown in FIG. 5). In examples, variants of supports which include multiple components and/or materials can include a bushing (e.g., to enable the support to maintain a vacuum in the interstitial vacuum space while optionally sliding relative to the jacket and/or inner tank, etc.), a retention element, and/or any other suitable types of support components. In such an example, a bushing can define a first surface (e.g., an inner surface, etc.) statically coupled to an outer surface of a support and a second surface defining a sliding interface with the jacket.

Supports are preferably neck-mounted (a.k.a., neck supports; neck mounts) to the inner tank and arranged along a central axis of the inner tank (and/or jacket), but can additionally or alternatively be diameter-mounted (e.g., at an outer diameter of the inner tank; arranged between domed end caps of the tank and/or jacket; etc.), and/or otherwise suitably configured. Additionally or alternatively, a support is preferably arranged proximal to the fill tube(s) and/or can be directly coupled to a fill tube to restrict relative motion between the inner tank and jacket between ends of the fill tube (e.g., which might otherwise induce extraneous strain deformation of the fill tube which could lead to fatigue or material failure). In a first example, a first and second support can mount the inner tank to the jacket at opposite ends of the inner tank along a central axis of the inner tank. In a second example, nonexclusive with the first, a plurality of supports can constrain the inner tank to the outer tank at an outer diameter of the inner tank.

The supports are preferably oriented around a principal axis (e.g., a central axis of the support, etc.) which can define a cylindrical coordinate system. The principal axis is preferably parallel and/or coincident with the central axis of the inner tank but can alternatively be otherwise oriented and/or located.

In variants, supports can each azimuthally span an angular range around the central axis or can provide point constraints at points along the inner tank's outer surface (e.g., an outer surface of the neck and/or an outer surface of a wide diametric width of the inner tank, etc.). In a first example, a single support can surround the central axis of the inner tank, jacket, and/or overall system circumferentially (e.g., in 360°; as a toroid, as an annulus, etc.). In a set of second examples, a support can surround the central axis of the inner tank non-circumferentially (e.g., 350°, 300°, 270°, 225°, 180°, 135°, 90°, 60 45°, 30°, 10°, 1°, within an open or closed range bounded by the aforementioned values, and/or within any other suitable range). In the set of second examples, the set of supports can include multiple supports cooperatively surrounding the at different azimuthal angles relative to the central axis. Alternatively, the supports can each provide a mechanical constraint at a particular azimuthal angle relative to the central axis around the tank (e.g., wherein supports cooperatively surround the tank). In a variant where supports do not fully azimuthally surround the central axis, using a coordinate system where an azimuthal angle of 0°is the vertical top of the inner tank, supports can be positively or negatively azimuthally-offset from the 0° position by 180°, 135°, 90°, 60 45°, 30°, 10°, 1°, within an open or closed range bounded by the aforementioned values, and/or at any other suitable offset.

The transverse profile of the supports (e.g., profile normal to a central axis of the support and/or central axis of the tank), can be regular or irregular. In a first variant, the shape of the supports are partial cylinders (e.g., the first and second end surfaces of the support are partial cylindrical surfaces connected by a pair of flat surfaces, example shown in FIG. 5, etc.). In a second variant, the shape of the supports are annular (e.g., the first and second end surfaces of the support are cylinders, etc.) However, the supports can have any other suitable shape.

In an example, the transverse profile of a support at a middle transverse plane of the support includes a plurality (e.g., 2, 3, 4, 5, 6, 7, 10, etc.) of discrete, non-touching concentric annuli (e.g., in a variant where the support is a boustrophedonic support, etc.). In this example, the concentric annuli are connected by a single extended surface following a boustrophedonic path (in the transverse plane) linking the annuli to one another.

The support(s) can be mechanically coupled to the inner tank and/or jacket to constrain: axial translation (a.k.a., X translation or longitudinal translation), radial translation (e.g., in two orthogonal directions; Y and/or Z translation; lateral translation, vertical translation, etc.), rotation (e.g., axial, lateral; SO(3) rotations; X, Y, and/or Z rotation; etc.), and/or can be otherwise constrained.

For example, supports preferably constrain at least 5 degrees of freedom, 6 degrees of freedom, and/or any other suitable number of degrees of freedom between the inner tank and the jacket. In a first example, a support can be fixed relative to the inner tank (e.g., mounted and/or mechanically coupled in all degrees of freedom). In a second example, a support can be fixed relative to the jacket (e.g., mounted and/or mechanically coupled in all degrees of freedom). In a third example, a support can allow motion or deformation in one or more degrees of freedom relative to the jacket (e.g., axial translation; axial rotation; etc.; with one, two, three, four, or five degrees of freedom constrained). In a fourth example, a support can allow motion or deformation in one or more degrees of freedom relative to the inner tank (e.g., axial translation; axial rotation; etc.; with one, two, three, four, or five degrees of freedom constrained).

However, variants of the system including supports which differentially constrain the inner tank can have any other suitable constraint difference between supports.

In a specific example, the supports can constrain the inner tank in 6 degrees of freedom at a first neck mount and 5 degrees of freedom at a second neck mount opposite the first neck mount along a central axis of a COPV, each relative to the jacket, where the axial position of the second neck mount is constrained by the axial length of the COPV inner wall, which may fully constrain (and avoid over constraining) the double-walled COPV.

However, the support(s) can mechanically couple the tank to the jacket in according to any suitable constraints.

The support(s) can be mechanically coupled to the inner tank, jacket, and/or any other suitable components by: mechanical fasteners (e.g., threaded fasteners, pins, clamps, etc.), threaded fastening, mechanical retention (e.g., clamps, press-fits, spring-lock mechanisms, positive retention mechanisms), spring retention (e.g., snap rings, spring clips, etc.), positive retention devices, mechanical interference/retention features (e.g., flats on D-shaft couplers, snap rings, retention collars, grooved shafts, etc.; example shown in FIG. 4A), and/or can be otherwise suitably mechanically coupled. Additionally or alternatively, in some variants the supports can be bonding (e.g., with bonding agents such as threadlock, epoxy, JB-weld, etc.), welded at one or more ends (e.g., TIG weld, friction weld, spot weld, etc.), and/or can be otherwise configured.

In an example, a support is an annular support with a mechanical fastener (e.g., a set of threads, etc.) connecting an outer end of the support (e.g., a distal surface of the support relative to the rotational axis of the support, etc.) to an inner end of the support (e.g. set of external threads fixed to an inner tank).

In a second example, the supports can include coaxial threads at either end (e.g., configured to respectively couple to the one end of the tank and jacket along the long axis of the tank).

In variants, at least one support can, with the inner tank and/or a jacket, cooperatively define a slidable interface to allow axial translation of the inner tank relative to the jacket. In a first variant, the slidable interface is between a sliding element and the jacket (e.g., which may be advantageous because of the relatively smaller temperature range at this end of the support, which may be more favorable for self-lubricating materials). In a second variant, the slidable interface can be between a sliding element and the inner tank (e.g., where the support structure is rigid relative to the jacket), and/or internally within the support (e.g., where a support assembly acts as a linear joint which is rigidly fixed to the inner tank and the jacket). However, the support(s) can define any other suitable degrees of freedom and/or slidable interfaces, and/or can be otherwise suitably configured.

In a first variant, both supports of a pair of supports can engage with the inner tank or jacket via a slidable interface. In a second variant, only one support of the pair of supports can engage with the inner tank or jacket via a slidable interface. In examples of either variant, a support can be fully or partially constrained from moving parallel with the central axis by a mechanical fastener (e.g., a snap ring, etc.) and a shoulder of the inner tank and/or jacket.

The slidable interface can define a sliding axis (e.g., an axis along which the support can slide relative to the jacket, etc.), which is preferably parallel with the central axis of the inner tank and/or the principal axis of the support but can alternatively be any other suitable axis.).

However, slidable interfaces can otherwise be implemented between the supports, the inner tank, and/or the outer tank.

The supports preferably include a metal body (e.g., stainless steel, titanium, aluminum; alloyed metals, etc.; as the primary structural element), but can additionally include or be used with polymers, self-lubricating materials/additives, insulators, and/or any other suitable materials/components.

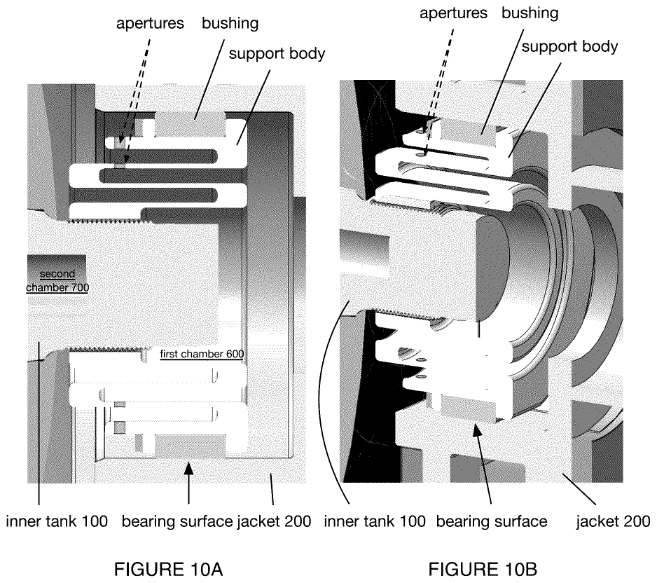

In variants, a support can include a sliding element between the inner tank and jacket. The sliding element can be fixed relative to the inner tank and can slide relative to the jacket, fixed relative to the jacket and can slide relative to the inner tank, can slide relative to both the jacket and the inner tank, and/or can otherwise be constrained. In variants, a sliding component can be or include a seal, a ring, a bushing and/or any other suitable annular component at a bearing surface along a slidable interface (e.g., between the support and the jacket, example shown in FIG. 10A and FIG. 10B, or between the support and the inner tank). The bearing surface is preferably a surface (e.g., a cylindrical surface, etc.) between the sliding element and the jacket but can alternatively be between the sliding element and the inner tank. However, the bearing surface can be at any other suitable position and/or couple any other suitable set(s) of components.

In a variant where the support divides portions of the first chamber with different pressures, the slidable interface can withstand a pressure differential (e.g., fluidly isolate the portions from each other, etc.). The pressure differential can be 0 bar, 1 bar, 1.013 bar, 2 bar, 5 bar, a pressure differential within an open or closed range bounded by the aforementioned values, and/or any other suitable pressure differential. However, the support can alternatively not divide portions of the first chamber at different pressures.

The sliding element can be self-lubricating (e.g., can be made of PTFE, TFM, POM, a graphite impregnated material, etc.). For instance, a self-lubricating material can be press-fit and/or shrink-fit with a support body as part of a support assembly (e.g., an example is shown in FIG. 5). As an example, a self-lubricating bushing can be secured by a mechanical pre-load (e.g., pre-tensioned hoop stress, such as may be achieved by a shrink fit), which may induce a strain in the material to mitigate expansionary effects of Coefficient of Thermal Expansion (CTE) mismatch between the bushing and the support body. For instance, in some materials a marginal temperature increase may cause a (circumferential) bushing to expand relative to the support, which may otherwise decouple the bushing without some corresponding preload. CTE mismatch may instead marginally relax the pre-loaded hoop stress in the bushing, with the pre-load effectively absorbing and/or mitigating deformations resulting from CTE mismatch. In particular, thermal interference fits (e.g., heating OD and/or cooling ID) and/or mechanical pre-tensioning (e.g., press-fit by hydraulic press) may be used to achieve sufficient preload, and combined pre-loading mechanism may be particularly advantageous where the nominal operating temperatures may have a range of over 100K (e.g., 150K, 200K, 250K, greater than 250K, etc.), as may arise for cyclically cryogenic conditions.

In alternative variants, a support can longitudinally deform to accommodate longitudinal motion of an inner tank while supporting the inner tank. In an example of such a variant, a support inner end can remain static relative to an inner tank and a support outer end can remain static relative to a jacket. For example, a support can include a set of metal bellows, elastomeric expansion joints, PTFE (polytetrafluoroethylene) expansion joints, and/or any other suitable mechanism for accommodating elastic deformation.

Supports are connected and thermally coupled to the jacket and the inner tank at a first (e.g., outer) end and second (e.g., inner) end, respectively, and can be configured to reduce heat conduction between the first and second ends. As an example, the first and second ends can be a pair of (concentric) cylindrical surfaces (e.g., partial cylinders, in the case of flats, retention features, etc.) of the supports, wherein the extended surfaces are annular and connect the pair of concentric cylinders. In this example, the first and second ends can surround the principal axis (e.g., which passes through the center points, etc.)

In variants, supports can include (insulating) extended (e.g., serpentine, etc.) surfaces between the first and second ends. Insulating extended surfaces can be arcuate, serpentine, boustrophedonic, wavy, spiraling, coiled, helical, pocketed, bent, and/or may have any other suitable structures/geometries within the annular body. However, the supports can include any other suitable geometry and/or (insulating) extended surfaces, and/or can otherwise reduce heat transfer between the first and second ends.

The supports (e.g., an extended surfaces thereof) can have a constant or changing axial profile (e.g., a profile in a plane including both a rotational axis of the support and a radial axis of the support). Examples of axial profiles include a shape following a non-straight path (e.g., a boustrophedonic path, a spiral, etc.), a lattice, an I-beam structure, a truss, and/or any other suitable geometric profile(s)/construction.

In variants where the axial profile of the supports follows a path (e.g., a boustrophedonic path, etc.), the path and/or resultant extended surfaces can be rectilinear (e.g., following a square wave, etc.), rectilinear with fillets, sinusoidal, zig-zag, rounded, and/or any other suitable shape. The path of an extended surfaces can include 1 switchback, 2 switchbacks, 3 switchbacks, 4 switchbacks, 5 switchbacks, 6 switchbacks, 8 switchbacks, 10 switchbacks, 15 switchbacks, 20 switchbacks, a number of switchbacks within an open or closed range bounded by the aforementioned values, and/or any other suitable number of switchbacks. The number of switchbacks can be the same between different supports or can differ between different supports.

In a variant where the axial profile of the supports follows a path, the axial profile of the support (e.g., of the extended surface) can follow a boustrophedonic path with a deep or shallow amplitude. The amplitude of such a boustrophedonic path and/or the amplitude of a resultant extended surface can be any suitable percentage of an overall length of a support in a direction parallel with a central axis of the support and/or inner tank (e.g., 10%, 20%, 30%, 50%, 70%, 80%, 90%, 95%, 99%, within an open or closed range bounded by the aforementioned values, and/or any other suitable percentage). The amplitude can be the same or different between different support bodies. The amplitudes at each switchback can be constant or changing between the inner end and outer end. A long portion of each switchback can be parallel to the rotational axis of the support, parallel to a radial axis perpendicular to the rotational axis, and/or oriented in any other suitable direction.

For a support body, a shortest path (e.g., shortest conductive thermal path, etc.) between an inner end and an outer end is preferably boustrophedonic (e.g., wherein the extended surfaces follow a boustrephedonic path, etc.) but can alternatively not be boustrephedonic.

A thickness of the extended surface (e.g., perpendicular to the path, etc.) can be constant or can change. The ratio of thickness of the extended surface at each turning point of the boustrophedonic path (e.g., at each “U-turn” or “S” curve) to the thickness at each length section (e.g., between consecutive “U-turns”) can be 100%, 150%, 200%, 400%, 600%, 1000%, 2000%, a ratio within an open or closed range bounded by the aforementioned values, and/or any other suitable ratio. A thickness of the extended surface (e.g., at a “U-turn,” at a length section, etc.) can be 0.25 inches, 0.5 inches, 0.75 inches, 1 inch, 1.5 inches, 2 inches, 3 inches, a thickness within an open or closed range bounded by the aforementioned values, and/or any other suitable thickness.

A ratio of a length of the support (e.g., in a direction parallel with the central axis of the support, a central axis of the inner tank, etc.) to a minimum thickness of the extended surface can be 1:1, 2:1, 5:1, 10:1, 20:1, 50:1, 100:1, 1000:1, a ratio within an open or closed range bounded by the aforementioned values, and/or any other suitable ratio.

A ratio of a annular thickness of the support (e.g., a straight-line distance between the inner end and outer end, etc.) to a minimum non-zero thickness of the extended surface can be 1:1, 2:1, 5:1, 10:1, 20:1, 50:1, 100:1, 1000:1, a ratio within an open or closed range bounded by the aforementioned values, and/or any other suitable ratio.

The support body can define continuous boustrophedonic extended surfaces (e.g., contiguous surfaces across a single component, etc.) but can additionally or alternatively define surfaces of any other suitable type.

As an example, the support body and continuous surfaces thereof can boustrophedonically couple a plurality of concentric annuli to yield a boustrophedonic heat flow path (e.g., an example is shown in FIG. 3) between the first and second ends.

In an example, the continuous surface is bounded by the inner end (e.g., an inner surface) and the outer end (e.g., an outer surface) of the support.

In variants, supports can optionally include a set of apertures which fluidly couple a first portion of the first chamber across a material thickness of the support body with a second portion of the first chamber, such that the first and second chambers may form a contiguous fluid envelope (e.g., where the first chamber is in vacuum communication with the second chamber, etc.) within the interstitial space between the jacket and the inner tank to reduce head losses and pressure differentials during (de-)pressurization of the first chamber. In an example, the aperture couples a first boustrephedonic surface proximal the inner tank to a second boustrephedonic surface proximal the jacket and opposite the first boustrephedonic surface. For example, where one or more supports may partially enclose a second portion of the fluid envelope (e.g., at distal end of a slidable interface; proximal to a retention element, bearing surface, neck; proximal to a fill tube, etc.), an aperture(s) may fluidly couple the partially enclosed portion of the envelope (e.g., the second portion) to the remainder of the fluid chamber (e.g., the first portion), which may prevent gas particles from being trapped while pulling a vacuum in the first chamber. In a first example, the second portion is a fill tube traversal fluid chamber, wherein the fill tube passes through the fill tube traversal fluid chamber outside of the jacket and inner tank. In a second example, the second portion is an expansion accommodation chamber on a longitudinally-distal side of a less constrained support (e.g., a sliding support, etc.). However, the second portion can be any other suitable volume defined by system components.

Apertures can extend radially through concentric annuluses or boustrophedonic path lengths of the supports (e.g., normal to a flat on a coupler such as a D-shaft; normal to an outer cylindrical surface; etc.), axially (e.g., between concentric annuli bodies), can be skewed, and/or can have any other suitable orientation/arrangement. As an example, apertures can be holes drilled radially, through an annulus (e.g., boustrophedonically connected to a plurality of concentric annuli; examples are shown in FIGS. 4A-B and FIG. 5), towards a rotational axis of the annulus. Apertures can extend through flat surfaces of the support, curved surfaces of the support, boustrophedonic surfaces of the support, and/or any other suitable types of surfaces of the support. Apertures are preferably offset from the principal axis of the support but alternatively be in another suitable position. The apertures can have a bore axis which is parallel to the principal axis, parallel to a radial axis, vertical, horizontal, and/or any other suitable bore axis direction. However, the support(s) can include any other suitable set of apertures and/or can exclude apertures altogether.

However, the system can include any other suitable set of supports.

The system can optionally include a set of (exterior) mounts 500, which can function to mount and structurally support the jacket (e.g., an example is shown in FIG. 7) at the tank exterior. Mounts can be integrated with the jacket and/or separate. Additionally, mounts can function to fix the set of supports relative to the jacket and/or can connect the jacket proximal to the set of supports, or can be otherwise configured. In an example, the mounts can support the jacket proximal the supports (e.g., at opposite longitudinal ends of the jacket, etc.). However, the system can alternatively exclude mounts altogether, can be mechanically supported by an external system(s), can be fully supported by a body structure(s) of the jacket (e.g., freestanding), and/or can be otherwise suitably implemented in any other suitable mounting configurations or arrangements.

However, the system can include any other suitable components.

### 5. Variants

In variants, the system can balance increased structural rigidity while reducing thermal conductance and constraining the inner tank to enable “breathing” (e.g., expansion/contraction due to changes in temperature and differential pressure).

Variants can include asymmetric stainless-steel vessel supports with a slidable interface along a self-lubricating surface (e.g., TFM, PTFE, etc.).

In a variant, the system can include a separate and distinct Front COPV Support and Rear COPV Support which are different from each other. The Front COPV Support at a front end (neck) of the inner tank can support a fill tube to allow the vessel to fuel and defuel. The Rear COPV Support can be at an opposite, rear end (e.g., rear neck; which can include or exclude a fill tube). The Front COPV Support can be constructed of a unitary body (e.g., CNC machined, cast, etc. ; without welds), such as a unitary metal (e.g., stainless steel). The Rear COPV Support can be an assembly (e.g., press-fit; shrink-fit; interference fit; etc.) of a plurality of components (e.g., an example is shown in FIG. 5). For example, the Rear COPV Support can include a self-lubricating bushing assembled with a metal support body (e.g., stainless steel body of unitary construction).

In a variant, the Front COPV Support is preferably coupled to the inner tank and the jacket and constrained in all degrees of freedom relative thereto (e.g., all Cartesian translations and body rotations SO(3); with a substantially rigid connection), which can prevent motion of the fill tube and components coupled to the fill tube. In this variant, the Rear COPV Support can constrain 5 degrees of freedom, allowing longitudinal relative motion to accommodate changes in tank volume (e.g., within a range of motion; axial along a central axis of the inner tank; at friction/plain bearing; an example is shown in FIG. 11).

In variants, the assembly of the Front COPV Support can include: 1. Assembly to the cup: Snap ring can be used to keep the Front SS COPV Support in place; and 2. Assembly to the COPV: Threaded connection with thread locker. In variants, the assembly of the Rear COPV Support can include: 1. Assembly of the Rear COPV Support (e.g., The Bushing heated up so that its inner diameter (ID) increases until it is possible to slide it in the Rear SS COPV Support, then the Backup ring and Rear Snap Ring are installed to keep the Bushing in place); 2. Assembly to the COPV: Threaded connection with thread locker; and 3. Assembly to the cup: Slide the cup over the TFM Bushing. However, the supports can be otherwise assembled.

Alternative embodiments implement the above methods and/or processing modules in non-transitory computer-readable media, storing computer-readable instructions. The instructions can be executed by computer-executable components integrated with the computer-readable medium and/or processing system. The computer-readable medium may include any suitable computer readable media such as RAMs, ROMs, flash memory, EEPROMs, optical devices (CD or DVD), hard drives, floppy drives, non-transitory computer readable media, or any suitable device. The computer-executable component can include a computing system and/or processing system (e.g., including one or more collocated or distributed, remote or local processors) connected to the non-transitory computer-readable medium, such as CPUs, GPUs, TPUS, microprocessors, or ASICs, but the instructions can alternatively or additionally be executed by any suitable dedicated hardware device.

Embodiments of the system and/or method can include every combination and permutation of the various system components and the various method processes, wherein one or more instances of the method and/or processes described herein can be performed asynchronously (e.g., sequentially), concurrently (e.g., in parallel), or in any other suitable order by and/or using one or more instances of the systems, elements, and/or entities described herein.

As a person skilled in the art will recognize from the previous detailed description and from the figures and claims, modifications and changes can be made to the preferred embodiments of the invention without departing from the scope of this invention defined in the following claims.

All references cited herein are incorporated by reference in their entirety, except to the extent that the incorporated material is inconsistent with the express disclosure herein, in which case the language in this disclosure controls.

Optional elements, which can be included in some variants but not others, are indicated in broken line in the figures.

Different subsystems and/or modules discussed above can be operated and controlled by the same or different entities. In the latter variants, different subsystems can communicate via: APIs (e.g., using API requests and responses, API keys, etc.), requests, and/or other communication channels. Communications between systems can be encrypted (e.g., using symmetric or asymmetric keys), signed, and/or otherwise authenticated or authorized.

Alternative embodiments implement the above methods and/or processing modules in non-transitory computer-readable media, storing computer-readable instructions that, when executed by a processing system, cause the processing system to perform the method(s) discussed herein. The instructions can be executed by computer-executable components integrated with the computer-readable medium and/or processing system. The computer-readable medium may include any suitable computer readable media such as RAMs, ROMs, flash memory, EEPROMs, optical devices (CD or DVD), hard drives, floppy drives, non-transitory computer readable media, or any suitable device. The computer-executable component can include a computing system and/or processing system (e.g., including one or more collocated or distributed, remote or local processors) connected to the non-transitory computer-readable medium, such as CPUs, GPUs, TPUS, microprocessors, or ASICs, but the instructions can alternatively or additionally be executed by any suitable dedicated hardware device.

Embodiments of the system and/or method can include every combination and permutation of the various system components and the various method processes, wherein one or more instances of the method and/or processes described herein can be performed asynchronously (e.g., sequentially), contemporaneously (e.g., concurrently, in parallel, etc.), or in any other suitable order by and/or using one or more instances of the systems, elements, and/or entities described herein. Components and/or processes of the following system and/or method can be used with, in addition to, in lieu of, or otherwise integrated with all or a portion of the systems and/or methods disclosed in the applications mentioned above, each of which are incorporated in their entirety by this reference.

As a person skilled in the art will recognize from the previous detailed description and from the figures and claims, modifications and changes can be made to the preferred embodiments of the invention without departing from the scope of this invention defined in the following claims.

We claim:

1. A system, comprising:
a support comprising at least three annuli which are boustrophedonically coupled by a continuous surface, the support defining:
a principal axis intersecting a respective center point of each of the at least three annuli;
a first region configured to mechanically couple the support to a pressure vessel; and
a second region surrounding the principal axis; and
a bushing, a first surface of the bushing mechanically coupled to the second region of the support, the bushing defining a slidable interface along a second surface of the bushing.

2. The system of claim 1, wherein, at the slidable interface, the bushing is configured to slide relative to a rigid enclosure.

3. The system of claim 1, wherein the continuous surface is bounded by the first region and the second region, wherein the support defines an aperture offset from the principal axis, the aperture fluidly coupling the continuous surface to a second continuous surface across a thickness of the support.

4. The system of claim 3, wherein the aperture is arranged within a curved surface of the support.

5. The system of claim 1, wherein a cross-section of the support defines a boustrophedonic boundary along the continuous surface, wherein an amplitude of the boustrophedonic boundary is over 50% of an overall length of the support, and wherein the overall length of the support is measured in a direction parallel with the principal axis.

6. The system of claim 1, wherein the first region comprises a neck mount for the pressure vessel.

7. A cryo-compression fluid storage system, comprising:
a composite overwrapped pressure vessel (COPV) defining:
a longitudinal centerline;
a first end; and
a second end, the second end opposite the first end along the longitudinal centerline;
a jacket, the jacket housing the COPV and cooperatively defining an interstitial fluid chamber with the COPV, wherein an outer surface of the COPV and an inner surface of the jacket are fluidly coupled to the interstitial fluid chamber;
a first tank support rigidly mounting the COPV to the jacket; and
a second tank support mechanically coupling the COPV to the jacket, wherein the second tank support defines a slidable interface along a translation axis parallel with the longitudinal centerline.

8. The cryo-compression fluid storage system of claim 7, wherein the interstitial fluid chamber defines a first vacuum pressure relative to the COPV and a second vacuum pressure relative to an ambient environment.

9. The cryo-compression fluid storage system of claim 8, wherein the second tank support comprises an aperture offset from a principal axis of the second tank support, wherein the aperture fluidly couples a first portion of the interstitial fluid chamber to a second portion of the interstitial fluid chamber across a thickness of the second tank support.

10. The cryo-compression fluid storage system of claim 8, wherein the first tank support and second tank support at least partially define a boundary of the interstitial fluid chamber.

11. The cryo-compression fluid storage system of claim 10, wherein the interstitial fluid chamber comprises a variable volume.

12. The cryo-compression fluid storage system of claim 11, wherein the jacket comprises a fixed volume.

13. The cryo-compression fluid storage system of claim 7, wherein the first tank support is mounted to a first neck of the COPV at the first end, and the second tank support is mounted to a second neck of the COPV at the second end.

14. The cryo-compression fluid storage system of claim 13, wherein each conductive thermal path connecting the COPV to the jacket passes through at least one of: the first neck or the second neck.

15. The cryo-compression fluid storage system of claim 7, wherein the second tank support boustrophedonically couples the COPV and the jacket through a plurality of concentric annuli.

16. The cryo-compression fluid storage system of claim 15, wherein the second tank support defines a minimum-length thermal conductance path between the COPV and the jacket, the minimum-length thermal conductance path boustrophedonically connecting the COPV and the jacket.

17. The cryo-compression fluid storage system of claim 7, wherein the system further comprises a first fill tube and second fill tube, each directly fluidly connected to an interior of the COPV.

18. The cryo-compression fluid storage system of claim 17, wherein at least one of the first fill tube and second fill tube passes through the interstitial fluid chamber.

19. The cryo-compression fluid storage system of claim 7, wherein a thermal elongation of the COPV between:
a first temperature less than 100°K; and
a second temperature greater than 250°K
is less than a length of the slidable interface between the second tank support and the jacket, wherein the length of the slidable interface is measured parallel to the longitudinal centerline.

20. The cryo-compression fluid storage system of claim 7, wherein the COPV is a type III composite overwrapped pressure vessel.
